(19) United States
(12) Patent Application Publication
(10) Pub. No.: US 2004/0192280 A1
(43) Pub. Date: Sep. 30, 2004

(54) System for updating application software of data acquisition devices

(75) Inventors: Bryan L. Dalton, Endicott, NY (US); Michael A. Heaton, Owego, NY (US)

Correspondence Address: TAROLLI, SUNDHEIM, COVELL & TUMMINO LLP, Suite 1111, 526 Superior Avenue, Cleveland, OH, 44114, US

(73) Assignee: Lockheed Martin Corporation

(21) Appl. No.: 10/808,896

(22) Filed: Mar. 25, 2004

Related U.S. Application Data
(60) Provisional application No. 60/457,618, filed on Mar. 26, 2003.

(51) Int. Cl. H04M 3/00

(52) U.S. Cl. 455/418

(57) ABSTRACT

A system upgrades a mobile data acquisition device. The system includes a software upgrade for use with the mobile data acquisition device. The software upgrade is located on a software management computer. The software management computer transfers the software upgrade from the software management computer to a local communications computer. The local communications computer transfers the software upgrade to the mobile data acquisition device. The local communications computer stores the software upgrade for transfer to other mobile data acquisition devices.

### FIELD OF INVENTION

The present invention relates to a system for updating software, and more specifically, to a system for remotely updating applications software for mobile devices.

### BACKGROUND OF THE INVENTION

A conventional data collection system may include a mobile unit utilizing applications software to collect and process data by a sequence of automated and/or manual operations. A typical automated process is the non-contact scanning of bar code data by means of a cyclically deflected laser beam or an image photosensor of the CCD type. Once a valid bar code reading has been obtained, a keypad may be manually operated to indicate an associated quantity. The user may then manually initiate a further operation, for example, the on-line transmission of the data to a remote host computer by a known means such as a radio frequency communications link.

### SUMMARY OF THE INVENTION

A system in accordance with the present invention upgrades a mobile data acquisition device. The system includes a software upgrade for use with the mobile data acquisition device. The software upgrade is located on a software management computer. The software management computer transfers the software upgrade from the software management computer to a local communications computer. The local communications computer transfers the software upgrade to the mobile data acquisition device. The local communications computer stores the software upgrade for transfer to other mobile data acquisition devices.

Another system in accordance with the present invention upgrades a software application. The system includes a data acquisition device for use with the software application, a software management computer, and a local communications computer. The software management computer transmits an upgrade of the software application from the software management computer to the data acquisition device. The local communications computer interconnects the data acquisition device and the software management computer. The local communications computer transfers the upgrade from the software management computer to the data acquisition device. The local communications computer also transfers the upgrade to another data acquisition device.

A computer program product in accordance with the present invention upgrades a software application. The computer program product includes: a first instruction for initiating communication between a mobile device and a software management computer; a second instruction for initiating transfer of an upgraded portion of the software application from the software management computer to the mobile device; and a third instruction for updating a master bill of materials index file by the software management computer reflecting the upgrade of the software application.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention;

FIG. 2 is a schematic representation of data for use with the present invention; and

FIG. 3 is a schematic representation of data for use with present invention;

FIG. 4 is a schematic representation of part of another example system in accordance with the present invention;

FIG. 5 is a schematic representation of another part of the example system of FIG. 4; and

FIG. 6 is a schematic representation of an example system for use with the present invention.

### DESCRIPTION OF AN EXAMPLE EMBODIMENT

A system in accordance with the present invention may upgrade software applications on a deployed fleet of mobile devices. An example system may utilize a network connection between the mobile devices, a local communications computer, and a remote software management computer. The mobile device may initiate a dedicated network connection from the local computer to the remote computer for the purpose of transmitting a required software upgrade to the site of the mobile devices and storing the software upgrade on the local computer. The software upgrade may then be distributed to all of the mobile devices at the site.

The system may contain two unique features that minimize network connection time and cost for dial-up connections: (1) the system only requires a transmission of an application over the network to a single mobile device at a site, after which the application may be distributed locally at the site; and (2) the system requires only the upgraded modules of an application be transmitted, instead of transmitting an entire application.

The system remotely upgrades applications software on a fleet of deployed mobile devices for a business or company in a systematic, automated, and efficient manner. The system supports multiple applications and different sets of applications that may be loaded onto the mobile devices.

The applications software may be centrally managed by a remote software management computer. Each mobile device may be located at a specific business site. Multiple mobile devices may be located at any one site. Each mobile device may communicate with the remote software management computer through a highly integrated charging/communications cradle, also located at the site.

The system thus may provide an efficient method by which only one transmission of an application software upgrade may occur per site, regardless of the number of mobile devices located at the site. The system further may provide a flexible method that only requires the upgraded modules within a software application to be transmitted. The system may still further provide a configurable method in which all applications software transmissions may be set to occur during non-business hours. The system may yet further ensure a totally automatic upgrade with no human intervention by the end user of the mobile device. The system may still further provide a verifiable method that ensures an applications software upgrade does not render a mobile device inoperable. The system may yet further provide a reliable method with retry capability that enables an applications software upgrade to resume where the upgrade left off in the event a network connection is lost.

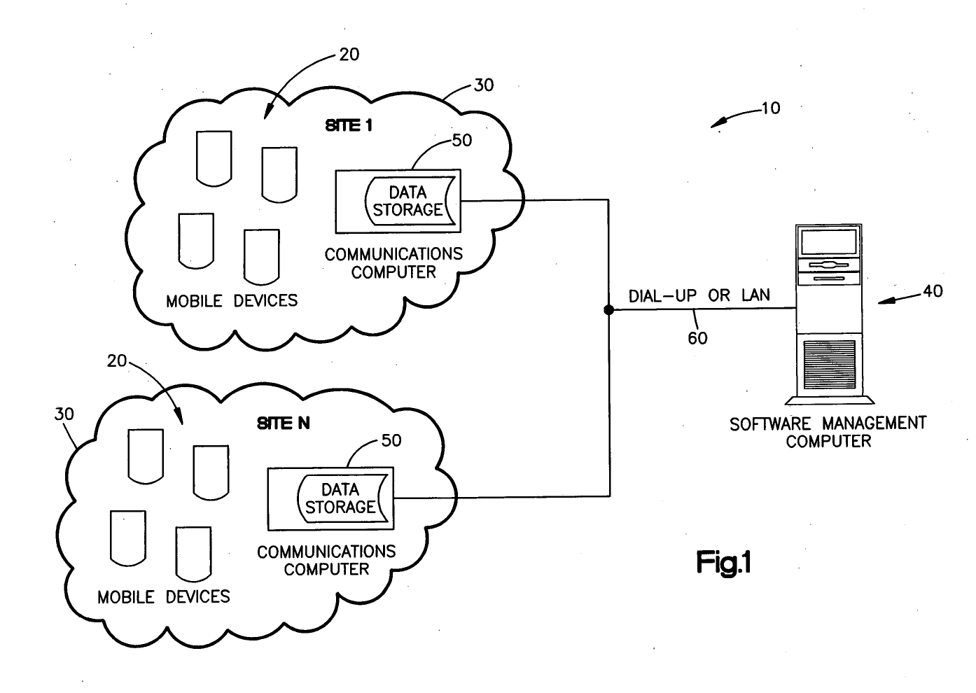

An example system 10 in accordance with the present invention is shown in FIG. 1. Several mobile devices 20 at multiple sites 30 communicate with the a software management computer through a connection 60 established by a local communications computer 50 located at each site 30. Each local communications computer 50 may serve as a conduit for data transmissions and provide a non-volatile storage area for software applications at each site 30.

The system 10 may employ two control mechanisms for determining whether a transmission of an upgraded software application may be attempted. First, a mobile device 20 must be docked in a corresponding charging cradle. A docked condition implies that the mobile device 20 is inactive and running on direct line power, instead of battery power. Second, a software application transmission may only be permitted if the current time falls within a configurable transmission window. Each site 30 may configure its own transmission window based on operation and usage at that site. A mobile device 20 may initiate a software application transmission only if the current local time at its corresponding site 30 falls within the transmission window of that corresponding site.

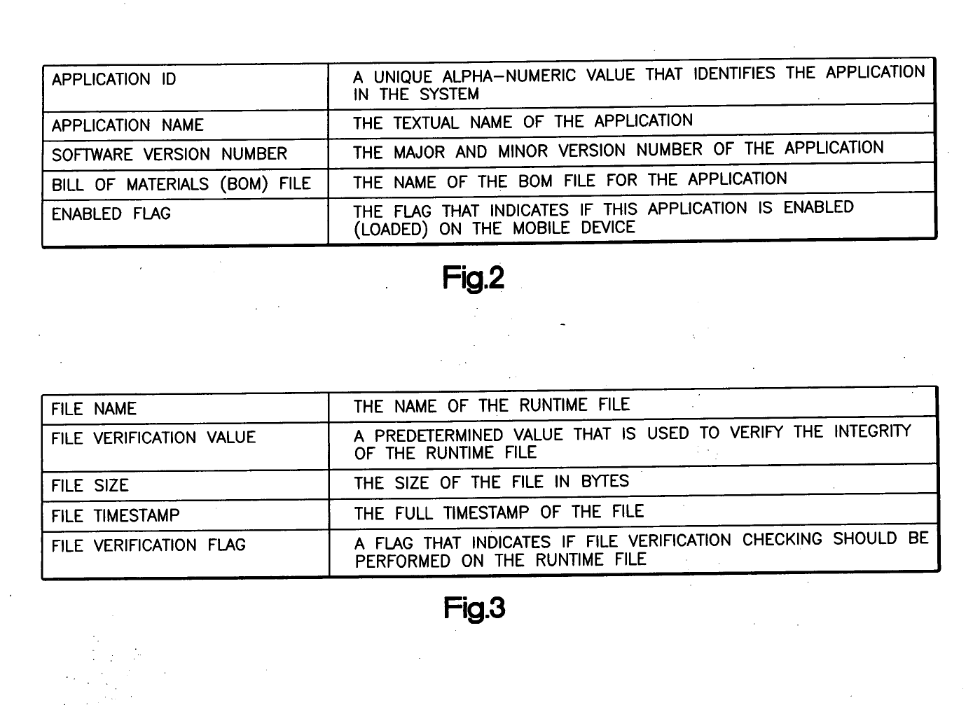

The system 10 may utilize Bill of Materials (BOM) files. BOM files help manage the system 10. Two types of BOM files are a single BOM Index file (FIG. 2) and one application BOM file per software application (FIG. 3).

The system 10 uses the BOM Index file as the primary identification of the software applications. A master BOM Index file may reside on the software management computer 40. A BOM Index file may also be loaded on each mobile device 20. The master BOM Index file on the software management computer 40 may indicate the complete list of software applications that are available in the system 10 and their associated version number. The BOM Index file on each mobile device 20 may indicate the software applications that are enabled (i.e., loaded) on that mobile device and associated version number of each software application.

A generic example of a BOM Index file may be: DEL0001, Delivery, 11.25, deliv.bom,1; INV0002, Inventory, 11.10, inv.bom, 0; COM0100, CommonBase, 2.0, reuse.bom, 1. There may be three entries in the BOM Index file for a mobile device—one for a Delivery application, one for an Inventory application, and one for a Common Base application of reusable components. In the above example, the Delivery application is enabled, but the Inventory application is not. The common base application may always be enabled.

The system 10 may upgrade and deploy the BOM Index file with every software application upgrade. The BOM Index file may be manually upgraded and placed on the software management computer 40 whenever a software application is modified or a new software application is created. For a software application that is modified, the version number for the software application may also be upgraded. For a new software application, a new entry may be added to the BOM Index file.

Each software application that runs on a mobile device 20 may have its own BOM file, which may identify individual modules that comprise the software application and specify file error checking data values for performing file verification after a transmission. The application BOM file format may consist of the fields shown in FIG. 3. The name of an application BOM file must match the name that is specified in the BOM Index file for the software application.

The system 10 may include an initial transmission of a software application to a site 30. The software application may be stored on the local communications computer 50. The system 10 may then distribute the software application to the mobile devices 20 located at the site 30.

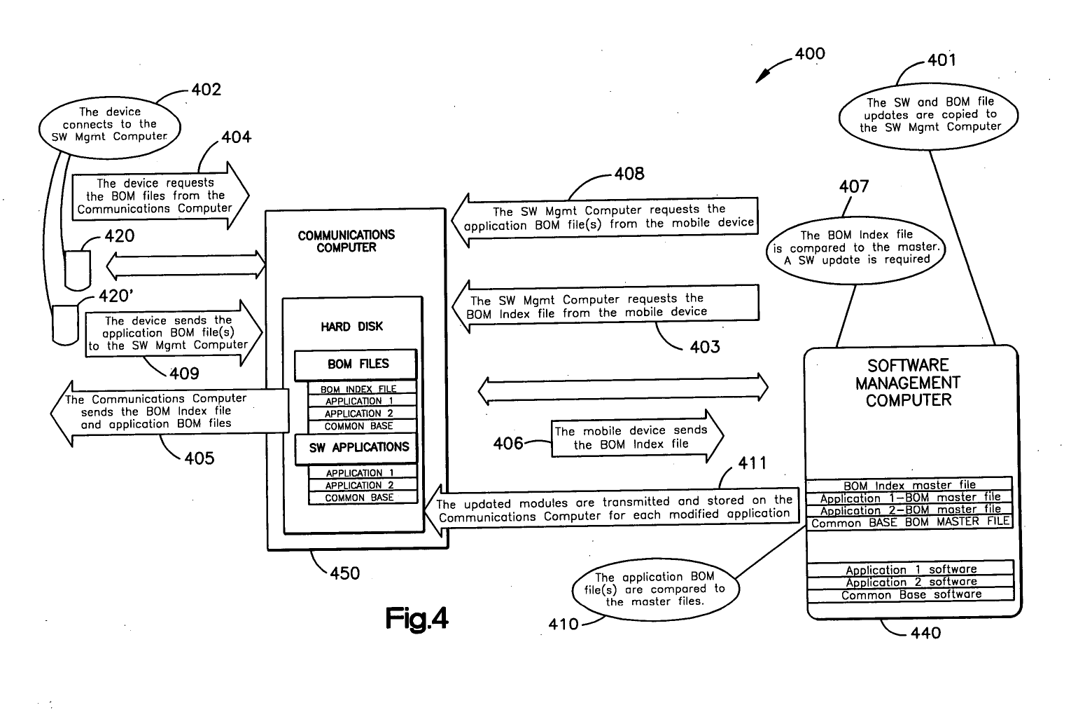

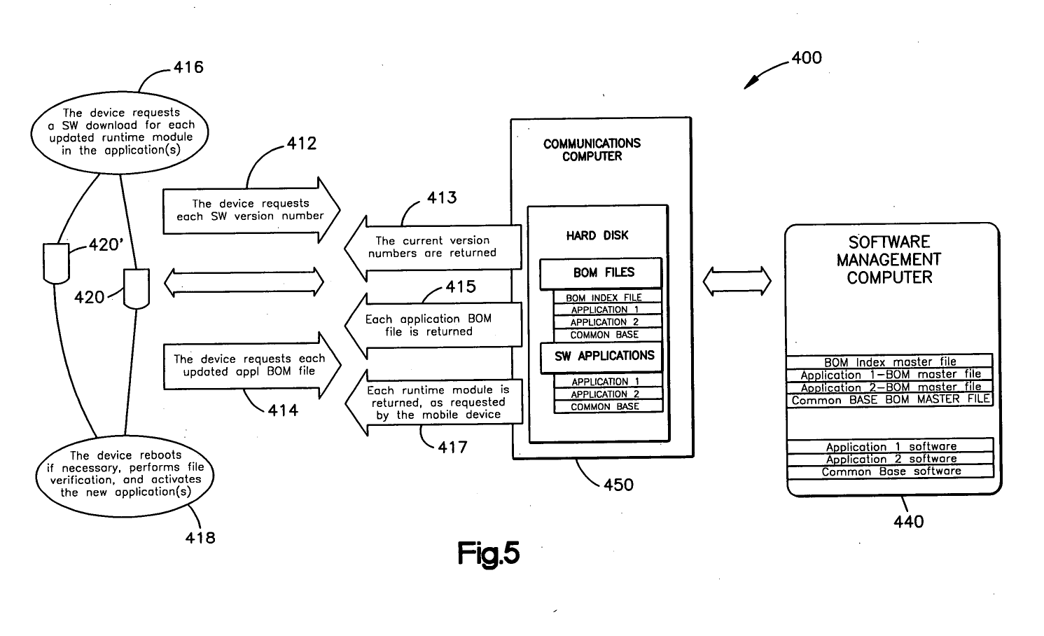

An example system 400 in accordance with the present invention may perform several individual steps, as shown in FIGS. 4 and 5. In step 401, the system 400 may install a new BOM Index file, Application BOM file(s), and software application(s) into designated directories on a software management computer 440. The software management computer 440 may be temporarily taken off-line while the files are manually installed (i.e., copies) onto the software management computer. Following step 401, if a mobile device 420 at a site is docked in a charging cradle and the current time is within a transmission window of the site, the system 400 proceeds to step 402. In step 402, the mobile device 420 may begin a conversation with the software management computer 440. The software management computer 440 may determine whether a software application upgrade is required. Following step 402, the system 400 proceeds to step 403 if a software application upgrade is required.

In step 403, the software management computer 440 requests the BOM Index file from the mobile device 420. Following step 403, the system 400 proceeds to step 404. In step 404, the mobile device 420 requests BOM file(s) from a local communications computer 450. Following step 404, the system 400 proceeds to step 405. In step 405, the local communications computer 450 sends the BOM Index file and software application BOM file(s) to the mobile device 420. Following step 405, the system 400 proceeds to step 406. In step 406, the mobile device 420 sends the BOM Index file to the software management computer 440. The version of the BOM Index file should be transmitted from the local communications computer 450 and not the mobile device 420. Otherwise, redundant and unnecessary upgrades may occur. Following step 406, the system 400 proceeds to step 407.

In step 407, the software management computer 440 compares all entries in the BOM Index file sent by the mobile device 420 to the master BOM Index file. If the version number of an entry in the BOM Index file sent by the mobile device 420 is less than the version number in the master BOM Index file, and the entry indicates the application is enabled at the site, then the system 400 determines that a software upgrade is required. Following step 407, the system 400 proceeds to step 408.

In step 408, the software management computer 440 requests each BOM file to be upgraded (i.e., each ‘back-level’ file) from the mobile device 420 through the local communications computer 450. Also in step 808, the system 400 must determine the specific modules (i.e., runtime files) belonging to the application(s) that must be transmitted. Following step 408, the system 400 proceeds to step 409. In step 409, the mobile device 420 sends the BOM file(s) to the software management computer 440. Following step 409, the system 400 proceeds to step 410.

In step 410, the system 400 identifies the entries in the application BOM file that do not match the current master BOM file for the application. Following step 410, the system 400 proceeds to step 411.

In step 411, the mobile device 420 and the software management computer 440 perform the required handshaking to ensure each upgraded module of each appropriate application is transmitted sequentially and stored on the local communications computer 450. After each module is transmitted, the mobile device 420 upgrades the entry for the module in the application BOM file on the local communications computer 450 to indicate the current timestamp, size, and file verification value. After transmission of all upgraded modules is complete, the conversation between the mobile device 420 and the software management computer 440, through the local communications computer 450, is concluded. At this point, the mobile device 420 knows that a software upgrade occurred, but does not know which application(s) were upgraded. Following step 411, the system 400 proceeds to step 412.

In step 412, the mobile device 420 sends a request to the local communications computer 450 to query the current version number for each enabled application in its BOM Index file. One request may be sent for each application. Following step 412, the system 400 proceeds to step 413.

In step 413, the local communications computer 450 returns the version number of the application to the mobile device 420 after locating the version number in the BOM Index file that has been transmitted from the software management computer 440 in step 411. Following step 413, the system 400 proceeds to step 414. In step 414, the mobile device 420 determines whether a version number is a back level number. If it is, mobile device 420 requests each updated BOM file from the local communications computer 450. Following step 414, the system 400 proceeds to step 415.

In step 415, the local communications computer 450 sends each updated application BOM file to the mobile device 420. Following step 415, the system 400 proceeds to step 416. In step 416, the mobile device 420 compares the new application BOM file(s) to the current one(s), looking for newer files by timestamp. Also in step 416, the mobile device 420 requests each upgraded module from the local communications computer 450. Following step 416, the system 400 proceeds to step 417.

In step 417, the local communications computer 450 sends each upgraded module, individually, to the mobile device 420. Following step 417, the system 400 proceeds to step 418. In step 418, when downloads are complete, the mobile device 420 reboots, if necessary, verifies the modules that are enabled for file verification, and activates the new software application(s).

When another mobile device 420′ at the site connects to the software management computer 440, the example system 400 may perform the same check for software upgrades. The BOM Index file may be retrieved from the local communications computer 450 and uploaded to the software management computer 440. The software management computer 440 may now determine that the applications software at the site is current and that no transmission is required. The mobile device 420′ then may request the BOM Index file from the local communications computer 450, determine that the application(s) is/are back level, and proceed to download the software application directly from the local communications computer 450, as described above.

In the event that the network connection between the mobile device and the software management computer is lost during transmission of software applications, the system 400 of FIGS. 4 and 5 may utilize a retry capability that ensures the transmission of modules during step 411 resumes with the module at the point of disruption.

When a next connection attempt begins, steps 402-410 may be repeated. During step 411, the software management computer 440 may use the application BOM file that was last transmitted from the mobile device 420 to determine which modules are (still) back level. Only the module that was being transmitted at the point of disruption, along with any upgraded modules that were not yet transmitted, may be sent to the mobile device 420.

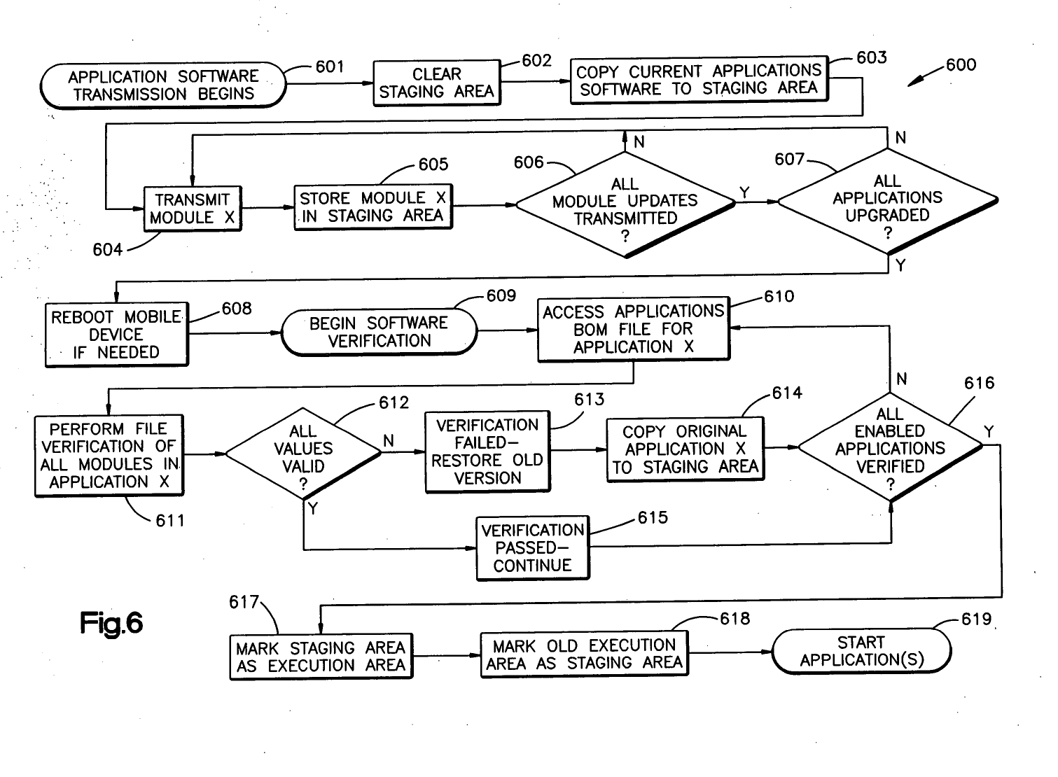

An upgrade of application software may render a mobile device useless. To avoid this, an example system 600 for use with the present invention may provide control and verification, as shown in FIG. 6.

The example system 600 initiates transmission of upgraded module(s) of software applications in step 601. Following step 601, the system 600 proceeds to step 602. In step 602, the system 600 clears a staging area in the mobile device for storing the upgraded module(s). Following step 602, the system 600 proceeds to step 603. In step 603, the system 600 copies current software applications to the staging area. Following step 603, the system 600 proceeds to step 603. In step 604, the system 600 transmits the upgraded modules of software applications to the staging area of the mobile device. Following step 604, the system 600 proceeds to step 605.

In step 605, the system 600 stores the upgraded modules in the staging area. Following step 605, the system 600 proceeds to step 606. In step 606, the system 600 determines whether all upgraded modules have been transmitted to the mobile device. If all upgraded modules have not been transmitted to the mobile device, the system 600 proceeds back to step 604. If all upgraded modules have been transmitted to the mobile device, the system 600 proceeds to step 607.

In step 607, the system 600 determines whether all the software applications have been upgraded. If all the software applications have not been upgraded, the system 600 proceeds back to step 604. If all the software applications have been upgraded, the system 600 proceeds to step 608.

In step 608, the system 600 reboots the mobile device, if necessary. Following step 608, the system 600 proceeds to step 609. In step 609, the system 600 begins software verification. Following step 609, the system 600 proceeds to step 610. In step 610, the system 600 accesses the BOM file for a specific software application. Following step 610, the system 600 proceeds to step 611. In step 611, the system 600 performs file verification of all modules in the software application. Following step 611, the system 600 proceeds to step 612.

In step 612, the system 600 determines whether all version values are valid. If all version values are not valid, the system 600 proceeds to step 613. If all version values are valid, the system 600 proceeds to step 615.

In step 613, the system 600 restores an old version of the software application. Following step 613, the system 600 proceeds to step 614. In step 614, the system 600 copies the original software application to the staging area. Following step 614, the system 600 proceeds to step 616.

In step 615, the system 600 continues with the valid version of the software application. Following step 616, the system 600 proceeds to step 616.

In step 616, the system 600 determines whether all enabled software applications have been verified. If all enabled software applications have not been verified, the system 600 proceeds back to step 610. If all enabled software applications have been verified, the system 600 proceeds to step 617.

In step 617, the system 600 marks the staging area as an execution area. Following step 617, the system 600 proceeds to step 618. In step 618, the system 600 marks an old execution area as a staging area. Following step 618, the system 600 proceeds to step 619. In step 619, the system 600 executes the software applications.

When the new software modules are transmitted to the mobile device, the modules may be stored in the staging area, as described above. The staging area may be required for two reasons: (1) the staging area may enable the upgraded modules to reside on the mobile device, co-existent with the current, non-upgraded, modules; and (2) the staging area may facilitate the verification process, which determines whether the modules may be activated.

Prior to transmission of any modules, the staging area may be cleared with the current modules for all applications being copied into the staging area. Copying all modules may ensure that the software applications may be complete in the event that all modules are not transmitted for the upgrade.

Subsequent to all of the upgraded modules being transmitted for all the enabled software applications, the mobile device may invoke a reboot, if necessary, and then invoke an initialization process. During the initialization process, the mobile device may verify the file verification value of all modules in the staging area, one application at a time, comparing the calculated value to the expected value in the BOM file of the software application. Only those modules that are enabled for file verification may be validated.

If an invalid file verification is detected, the original application is restored. All modules for the application may be copied from the current execution area into the staging area. If all file verification values for the software application are valid, then the system proceeds to the next software application. After all software applications have been verified, the staging area may be marked as the execution area, the old execution area may be marked as the staging area for the next upgrade, and the software application may be started.

Another example system 400 upgrades a mobile data acquisition device 420. The system 400 includes a software upgrade for use with the mobile data acquisition device 420. The software upgrade is located on a software management computer 440. The software management computer 440 transfers the software upgrade from the software management computer to a local communications computer 450. The local communications computer 450 transfers the software upgrade to the mobile data acquisition device 420. The local communications computer 450 stores the software upgrade for transfer to other mobile data acquisition devices 420′.

Still another example 400 upgrades a software application. The system 400 includes a data acquisition device 420 for use with the software application, a software management computer 440, and a local communications computer 450. The software management computer 440 transmits an upgrade of the software application from the software management computer to the data acquisition device 420. The local communications computer 450 interconnects the data acquisition device 420 and the software management computer 440. The local communications computer 450 transfers the upgrade from the software management computer 440 to the data acquisition device 420. The local communications computer 450 also transfers the upgrade to another data acquisition device 420′.

An example computer program product 400 upgrades a software application. The computer program product 400 includes: a first instruction for initiating communication between a mobile device 420 and a software management computer 440; a second instruction for initiating transfer of an upgraded portion of the software application from the software management computer 440 to the mobile device 420; and a third instruction for updating a master bill of materials index file by the software management computer 440 reflecting the upgrade of the software application.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for upgrading a mobile data acquisition device, said system comprising:
a software upgrade for use with the mobile data acquisition device, the software upgrade being located on a software management computer,
the software management computer transferring the software upgrade from the software management computer to a local communications computer,
the local communications computer transferring the software upgrade to the mobile data acquisition device, the local communications computer storing the software upgrade for transfer to other mobile data acquisition devices.

2. The system as set forth in claim 1 wherein the software management computer stores a master bill of materials file for the software upgrade.

3. The system as set forth in claim 2 wherein the local communications computer stores a local bill of materials file for the software upgrade.

4. The system as set forth in claim 3 wherein the master bill of materials file and the local bill of materials file are compared for determining a version of the software upgrade held by the mobile data acquisition device.

5. The system as set forth in claim 1 wherein the mobile data acquisition device verifies a version of the software upgrade held by the mobile data acquisition device.

6. The system as set forth in claim 1 wherein the mobile data acquisition device reboots subsequent to obtaining the software upgrade.

7. The system as set forth in claim 1 wherein the software upgrade is the upgraded part of an entire software application.

8. The system as set forth in claim 1 wherein the mobile data acquisition device maintains a staging area for temporarily storing the software upgrade.

9. The system as set forth in claim 1 wherein the mobile data acquisition device restores a prior version of the software upgrade if the verification of the software upgrade fails.

10. The system as set forth in claim 1 wherein the mobile data acquisition device marks a staging area as an execution area and marks an execution area as a staging area.

11. A system for upgrading a software application, said system comprising:
a data acquisition device for use with the software application;
a software management computer for transmitting an upgrade of the software application from said software management computer to said data acquisition device,
a local communications computer for interconnecting said data acquisition device and said software management computer, said local communications computer transferring the upgrade from said software management computer to said data acquisition device,
said local communications computer also transferring the upgrade to at least one other data acquisition device.

12. The system as set forth in claim 11 wherein said data acquisition device initiates transfer of the upgrade of the software application from said software management computer through said local communications computer.

13. The system as set forth in claim 11 wherein said local communications computer stores the upgrade for other data acquisition devices.

14. The system as set forth in claim 11 wherein said data acquisition device acknowledges receipt of the upgrade from said software management computer.

15. A computer program product for upgrading a software application, said computer program product comprising:
a first instruction for initiating communication between a mobile device and a software management computer;
a second instruction for initiating transfer of an upgraded portion of the software application from the software management computer to the mobile device; and
a third instruction for updating a master bill of materials index file by the software management computer reflecting the upgrade of the software application.

16. The computer program product as set forth in claim 15 further including a fourth instruction for transferring the upgrade through a local communications computer.

17. The computer program product as set forth in claim 15 further including a fourth instruction for rebooting the mobile device.

18. The computer program product as set forth in claim 15 further including a fourth instruction for activating the upgrade of the software application on the mobile device.

19. The computer program product as set forth in claim 15 further including a fourth instruction for maintaining a staging area on the mobile device for the upgrade.

20. The computer program product as set forth in claim 15 further including a fourth instruction for upgrading the software application on another mobile device.
